(19) United States
(12) Patent Application Publication
(10) Pub. No.: US 2025/0260450 A1
(43) Pub. Date: Aug. 14, 2025

(54) TECHNIQUES FOR JOINT CHANNEL STATE INFORMATION TRAINING AND PRECODER MATRIX INDICATOR FEEDBACK FOR ARTIFICIAL INTELLIGENCE-ENABLED NETWORKS

(71) Applicant: Lenovo (Singapore) Pte. Ltd., Singapore (SG)

(72) Inventors: Ahmed Hindy, Aurora, IL (US); Vijay Nangia, Woodridge, IL (US); Razvan-Andrei Stoica, Witten (DE)

(21) Appl. No.: 18/857,136

(22) PCT Filed: Apr. 17, 2023
(86) PCT No.: PCT/IB2023/053929

§ 371 Date: Oct. 15, 2024

Related U.S. Application Data
(60) Provisional application No. 63/331,579, filed on Apr. 15, 2022.

(51) Int. Cl. H04B 7/06; H04W 72/0446; H04W 72/0453

(52) U.S. Cl. CPC H04B 7/0626; H04B 7/0639; H04W 72/0446; H04W 72/0453

(57) ABSTRACT

Various aspects of the present disclosure relate to techniques for joint CSI training and PMI feedback for AI-enabled networks. A user equipment (UE)s configured to receive, based on a CSI reporting setting, a set of RSs for a channel measurement corresponding to an NZP CSI-RS resource, generate a CSI report based on the channel measurement, the CSI report comprising precoding matrix information for a precoding matrix and a set of coefficients that correspond to at least one dimension of the precoding matrix, and transmit the CSI report to a network.

### FIELD

The subject matter disclosed herein relates generally to wireless communications and more particularly relates to techniques for joint channel state information (“CSI”) training and precoder matrix indicator (“PMI”) feedback for artificial intelligence (“AI”)-enabled networks.

### BACKGROUND

A wireless communications system may include one or multiple network communication devices, such as base stations, which may be otherwise known as an eNodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (“3G”) radio access technology, fourth generation (“4G”) radio access technology, fifth generation (“5G”) radio access technology, among other suitable radio access technologies beyond 5G (e.g., sixth generation (“6G”)). In the wireless communications system, one or more of the network communication devices (e.g., base stations) or the user communication devices (e.g., UEs) may support one or multiple CG configurations for wireless communications (e.g., downlink communications, uplink communications).

### BRIEF SUMMARY

Disclosed are solutions for techniques for joint CSI training and PMI feedback for AI-enabled networks.

In one embodiment, a first apparatus includes a processor and a memory that is coupled to the processor. In one embodiment, the memory includes instructions that are executable by the processor to receive, based on a CSI reporting setting, a set of reference signals (“RSs”) for channel measurement corresponding to at least one non-zero power (“NZP”) CSI-RS resource, generate a CSI report, based on the channel measurement, that comprises precoding matrix information for a precoding matrix and a set of coefficients that correspond to at least one dimension of the precoding matrix, and transmit the CSI report.

In one embodiment, a first method receives, based on a CSI reporting setting, a set of RSs for channel measurement corresponding to an NZP CSI-RS resource and generates a CSI report, based on the channel measurement, that comprises precoding matrix information for a precoding matrix and a set of coefficients that correspond to at least one dimension of the precoding matrix. In one embodiment, the first method transmits the CSI report.

In one embodiment, a second apparatus includes a processor and a memory coupled to the processor. In one embodiment, the memory includes instructions that are executable by the processor to transmit, to a UE, a CSI reporting setting for configuring the UE for at least one of channel measurement and reporting, transmit, to the UE, a set of RSs for channel measurement corresponding to an NZP CSI-RS resource, and receive, from the UE, a CSI report. In one embodiment, the CSI report includes precoding matrix information for a precoding matrix and a set of coefficients that correspond to at least one dimension of the precoding matrix, the precoding matrix comprising a first basis transformation associated with a first dimension of the at least one dimension of the precoding matrix, the set of coefficients corresponding to the precoding matrix decomposed to two subsets of coefficients corresponding to different indices of the first dimension of the precoding matrix, a first subset of the two subsets of coefficients associated with a second basis transformation associated with a second dimension of the precoding matrix, and a second subset of the two subsets of coefficients associated with a third basis transformation associated with the second dimension of the precoding matrix.

In one embodiment, the second method transmits, to a UE, a CSI reporting setting for configuring the UE for at least one of channel measurement and reporting. In one embodiment, the second method transmits, to the UE, a set of RSs for channel measurement corresponding to an NZP CSI-RS resource. In one embodiment, the second method receives, from the UE, a CSI report, the CSI report comprising precoding matrix information for a precoding matrix and a set of coefficients that correspond to at least one dimension of the precoding matrix, the precoding matrix comprising a first basis transformation associated with a first dimension of the at least one dimension of the precoding matrix, the set of coefficients corresponding to the precoding matrix decomposed to two subsets of coefficients corresponding to different indices of the first dimension of the precoding matrix, a first subset of the two subsets of coefficients associated with a second basis transformation associated with a second dimension of the precoding matrix, and a second subset of the two subsets of coefficients associated with a third basis transformation associated with the second dimension of the precoding matrix.

### BRIEF DESCRIPTION OF THE DRAWINGS

FIG. 1 illustrates an example of a wireless communications system that supports techniques for joint CSI training and PMI feedback for AI-enabled networks in accordance with aspects of the present disclosure.

FIG. 2 illustrates an example of an aperiodic trigger state defining a list of CSI report settings that supports techniques for joint CSI training and PMI feedback for AI-enabled networks in accordance with aspects of the present disclosure.

FIG. 3 illustrates an example of an aperiodic trigger state definition indicating the resource set and quasi co-location (“QCL”) information that supports techniques for joint CSI training and PMI feedback for AI-enabled networks in accordance with aspects of the present disclosure.

FIG. 4 illustrates an example of a radio resource control (“RRC”) configuration for NZP CSI-RS resources that supports techniques for joint CSI training and PMI feedback for AI-enabled networks in accordance with aspects of the present disclosure.

FIG. 5 illustrates an example of an RRC configuration for CSI interference measurement (“CSI-IM”) resource that supports techniques for joint CSI training and PMI feedback for AI-enabled networks in accordance with aspects of the present disclosure.

FIG. 6 illustrates an example of a partial CSI omission for physical uplink shared channel (“PUSCH”)-based CSI that supports techniques for joint CSI training and PMI feedback for AI-enabled networks in accordance with aspects of the present disclosure.

FIG. 7 illustrates an example of an NR protocol stack that supports techniques for joint CSI training and PMI feedback for AI-enabled networks in accordance with aspects of the present disclosure.

FIG. 8 illustrates an example of a UE apparatus that supports techniques for joint CSI training and PMI feedback for AI-enabled networks in accordance with aspects of the present disclosure.

FIG. 9 illustrates an example of a network equipment (“NE”) apparatus that supports techniques for joint CSI training and PMI feedback for AI-enabled networks in accordance with aspects of the present disclosure.

FIG. 10 illustrates a flowchart of a method that supports techniques for joint CSI training and PMI feedback for AI-enabled networks in accordance with aspects of the present disclosure.

FIG. 11 illustrates a flowchart of a method that supports techniques for joint CSI training and PMI feedback for AI-enabled networks in accordance with aspects of the present disclosure.

### DETAILED DESCRIPTION

Generally, the present disclosure describes systems, methods, and apparatuses for techniques for joint CSI training and PMI feedback for AI-enabled networks. In third generation partnership project (“3GPP”) new radio (“NR”) networks, CSI feedback in frequency division duplex (“FDD”) networks is reported by the UE to the network, where the CSI feedback is compressed via transformation of the channel over the spatial domain, frequency domain, or both, with pre-determined sets of spatial and frequency basis vectors, respectively. In addition to conventional CSI feedback mechanisms, AI/machine learning (“ML”)-enabled CSI acquisition schemes are considered strong candidates for future generations of 3GPP NR networks.

Although AI/ML-enabled schemes are often perceived as competitors to the conventional CSI feedback schemes, most AI/ML-enabled CSI acquisition schemes would still require some feedback from the UE to the network corresponding to CSI components that cannot be inferred from the AI/ML model, e.g., CSI components that are statistically independent over time, and hence cannot be inferred from the training data. Additionally, obtaining ubiquitous training data for the AI/ML-enabled schemes is instrumental to maintain the robustness of the AI/ML-enabled CSI acquisition scheme against variations in the environment that would lead to drifts in the channel distribution and hence requires updating the AI/ML model.

Given the foregoing, a CSI feedback mechanism is proposed that aims at jointly providing CSI feedback from the network to the UE corresponding to a precoder codebook, as well as provide training data to the network. Note that the CSI reported via conventional CSI feedback schemes may not be as useful as raw CSI feedback, since the CSI feedback reported via conventional methods is compressed in either spatial domain, frequency domain, or both.

In conventional solutions, CSI feedback, e.g., Type-I and Type-II codebook, is used for training the AI/ML model. A drawback to this approach is that CSI feedback in Type I, Type II codebooks is already compressed in spatial domain, frequency domain, or both. Providing the model with compressed CSI feedback using a pre-configured compression method would restrict the AT/ML model capability to design a proper compression scheme for CSI feedback.

In another conventional solution, specifying a new framework for AI/ML-based CSI reporting configuration, e.g., explicit AI-based CSI configuration, measurement, and reporting. A drawback to this approach is significant specification impact corresponding to defining the new measurement, reporting and feedback frameworks.

The solutions described in this disclosure include configuring the UE for providing feedback in the form of a CSI report comprising CSI that corresponds to a codebook for a precoder, where the first subset of the CSI is reported in a compressed/transformed domain corresponding to reduced CSI feedback overhead, and where the second subset of the CSI is reported in an uncompressed/untransformed domain so that it can be used for AI/ML model training in addition to the codebook identification. Note that both subsets of CSI jointly correspond to a PMI, so they can still be used for precoder information feedback.

In one embodiment, based on the AI/ML model inference at the network side, the network configures the UE with a selected subset of CSI compression types from a set of pre-configured CSI compression types, wherein a CSI compression type corresponds to a dimension of the PMI, e.g., spatial dimension, frequency/delay domain dimension and time/Doppler domain dimension. Additionally, different quantization schemes for the precoder coefficients can be configured based on the AI/ML-based inference of the distribution of both the amplitudes and phases of the precoder coefficients.

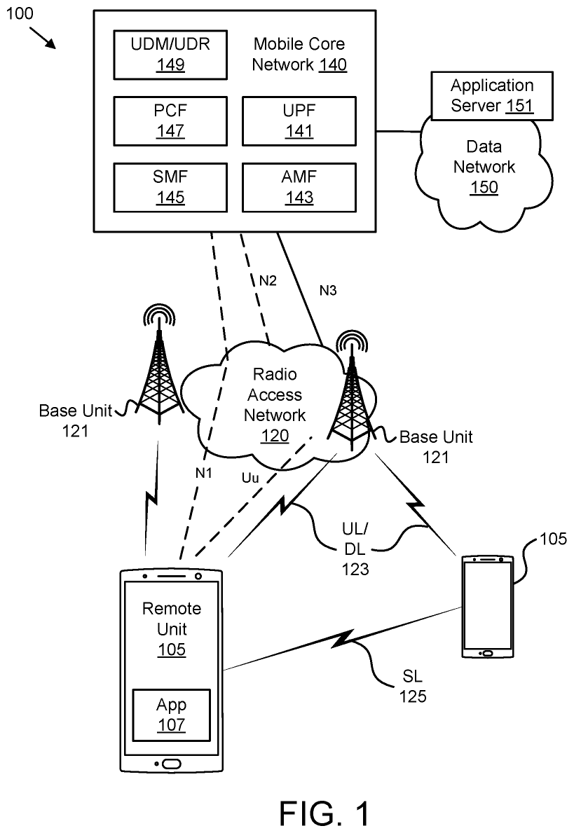

FIG. 1 depicts a wireless communication system 100 supporting techniques for joint CSI training and PMI feedback for AI-enabled networks, according to embodiments of the disclosure. In one embodiment, the wireless communication system 100 includes at least one remote unit 105, a radio access network (“RAN”) 120 (e.g., a NG-RAN), and a mobile core network 140. The RAN 120 and the mobile core network 140 form a mobile communication network. The RAN 120 may be composed of a base unit 110 with which the remote unit 105 communicates using wireless communication links 115. Even though a specific number of remote units 105, base units 110, wireless communication links 115, RANs 120, and mobile core networks 140 are depicted in FIG. 1, one of skill in the art will recognize that any number of remote units 105, base units 110, wireless communication links 115, RANs 120, and mobile core networks 140 may be included in the wireless communication system 100.

In one implementation, the RAN 120 is compliant with the 5G system specified in the 3GPP specifications. In another implementation, the RAN 120 is compliant with the LTE system specified in the 3GPP specifications. More generally, however, the wireless communication system 100 may implement some other open or proprietary communication network, for example WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 110 in the RAN 120 via uplink (“UL”) and downlink (“DL”) communication signals. Furthermore, the UL and DL communication signals may be carried over the wireless communication links 115. Here, the RAN 120 is an intermediate network that provides the remote units 105 with access to the mobile core network 140.

In some embodiments, the remote units 105 communicate with an application server 151 via a network connection with the mobile core network 140. For example, an 20 application 107 (e.g., web browser, media client, telephone/VoIP application) in a remote unit 105 may trigger the remote unit 105 to establish a PDU session (or other data connection) with the mobile core network 140 via the RAN 120. The mobile core network 140 then relays traffic between the remote unit 105 and the application server 151 in the packet data network 150 using the PDU session. Note that the remote unit 105 may establish one or more PDU sessions (or other data connections) with the mobile core network 140. As such, the remote unit 105 may concurrently have at least one PDU session for communicating with the packet data network 150 and at least one PDU session for communicating with another data network (not shown).

The base units 110 may be distributed over a geographic region. In certain embodiments, a base unit 110 may also be referred to as an access terminal, an access point, a base, a base station, a Node-B, an eNB, a gNB, a Home Node-B, a relay node, a RAN node, or by any other terminology used in the art. The base units 110 are generally part of a RAN, such as the RAN 120, that may include one or more controllers communicably coupled to one or more corresponding base units 110. These and other elements of radio access network are not illustrated but are well known generally by those having ordinary skill in the art. The base units 110 connect to the mobile core network 140 via the RAN 120.

The base units 110 may serve a number of remote units 105 within a serving area, for example, a cell or a cell sector, via a wireless communication link 115. The base units 110 may communicate directly with one or more of the remote units 105 via communication signals. Generally, the base units 110 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 110. Note that during NR-U operation, the base unit 110 and the remote unit 105 communicate over unlicensed radio spectrum.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”) 141. The mobile core network 140 also includes multiple control plane functions including, but not limited to, an Access and Mobility Management Function (“AMF”) 143 that serves the RAN 120, a Session Management Function (“SMF”) 145, a Policy Control Function (“PCF”) 147, and a Unified Data Management function (“UDM”) 149.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like. In certain embodiments, the mobile core network 140 may include a AAA server.

While FIG. 1 depicts components of a 5G RAN and a 5G core network, the described embodiments apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF may be mapped to an MME, the SMF mapped to a control plane portion of a PGW and/or to an MME, the UPF map to an SGW and a user plane portion of the PGW, the UDM/UDR maps to an HSS, etc.

In the following descriptions, the term “gNB” is used for the base station but it is replaceable by any other radio access node, e.g., RAN node, eNB, BS, eNB, gNB, AP, NR, etc. Further the operations are described mainly in the context of 5G NR. However, the proposed solutions/methods are also equally applicable to other mobile communication systems supporting CSI reporting.

Regarding NR Rel. 15 Type-II Codebook, assume the gNB is equipped with a 2D antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂ CSI-RS ports are utilized to enable DL channel estimation with high resolution for NR Rel. 15 Type-II codebook. To reduce the UL feedback overhead, a discrete Fourier transform (“DFT”)-based CSI compression of the spatial domain is applied to L dimensions per polarization, where L<N₁N₂. In the sequel the indices of the 2L dimensions are referred as the SD basis indices. The magnitude and phase values of the linear combination coefficients for each sub-band are fed back to the gNB as part of the CSI report. The 2N₁N₂×N₃ codebook per layer takes on the form:

W=W₁W₂,

where B is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W₂ is a 2Lx N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W₂ are independent for different layers.

Regarding NR Rel. 15 Type-II Port Selection Codebook, only K (where K≤2N₁N₂) beamformed CSI-RS ports are utilized in DL transmission, in order to reduce complexity. The. The K×N₃ codebook matrix per layer takes on the form:

W=W₁^{PS}W₂.

Here, W₂ follow the same structure as the conventional NR Rel. 15 Type-II Codebook and are layer specific. W₁^{PS} is a Kx2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is an RRC parameter which takes on the values {1, 2, 3, 4}under the condition d_{PS}≤min(K/2, L), whereas m_{PS} takes on the values

$$\{ 0 , ... , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , \\ [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \text{} \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] ,$$

$$[ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0, 1, 2, 3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0, 1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

The NR Rel. 15 Type-I codebook is the baseline codebook for NR, with a variety of configurations. The most common utility of Rel. 15 Type-I codebook is a special case of NR Rel. 15 Type-II codebook with L=1 for RI=1,2, wherein a phase coupling value is reported for each sub-band, i.e., W₂ is 2×N₃, with the first row equal to [1, 1, . . . , 1] and the second row equal to [e^{j2πø}^{₀}, . . . , e^{j2πø}^{_{N3-1}}]. Under specific configurations, ϕ₀=ϕ₁ . . . =ϕ, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

Regarding the NR Rel. 16 Type-II Codebook, assume the gNB is equipped with a two-dimensional (“2D”) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. To reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part ofthe CSI report. The 2N₁N₂×N₃ codebook per layer takes on the form:

W=W₁W₂W_{f}^{H},

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers.

W_{f} is an N₃×M matrix (M<N₃) with columns selected from a critically sampled size-N₃ DFT matrix, as follows:

$${W}_{f} = [ \begin{matrix}{f}_{{k}_{0}} & {f}_{{k}_{1}} & … & {f}_{{k}_{M ′ - 1}} ]\end{matrix} , 0 \leq {k}_{i} < {N}_{3} - 1 ,$$

$${f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T} .\end{matrix}$$

Only the indices of the L selected columns of B are reported, along with the oversampling index taking on O₁O₂ values. Similarly, for W_{F}, only the indices of the M selected columns out of the predefined size-N₃ DFT matrix are reported. In the sequel the indices of the M dimensions are referred as the selected Frequency Domain (“FD”) basis indices. Hence, L, M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Note that Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude, and phase values of a maximum of └2βLM┘-1 coefficients (along with the indices of selected L, M DFT vectors) are reported per layer, leading to significant reduction in CSI report size, compared with reporting 2N₁N₂×N₃-1 coefficients' information.

Regarding NR Rel. 16, Type-II Port Selection codebook, only K (where K≤2N₁N₂) beamformed CSI-RS ports are utilized in DL transmission, to reduce complexity. The K×N₃ codebook matrix per layer takes on the form:

W=W₁^{PS}\tilde{W}₂W_{f}^{H}.

Here, \tilde{W}₂ and W₃ follow the same structure as the conventional NR Rel. 16 Type-II Codebook, where both are layer specific. The matrix W¹^{^{PS}} is a Kx2L block-diagonal matrix with the same structure as that in the NR Rel. 15 Type-II Port Selection Codebook.

The codebook report is partitioned into two parts based on the priority of information reported. Each part is encoded separately (Part 1 has a possibly higher code rate). Below we list the parameters for NR Rel. 16 Type-II codebook only. More details can be found in TS 38.214 Sec 5.2.3-4.

### The CSI Report Contains:

a. Part 1: RI+CQI+Total number of coefficients
b. Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning is required to allow dynamic reporting size for codebook based on available resources in the uplink phase. More details can be found in TS 38.214 Sec 5.2.3.

Also Type-II codebook is based on aperiodic CSI reporting, and only reported in PUSCH via DCI triggering (one exception). Type-I codebook can be based on periodic CSI reporting (e.g., physical uplink control channel (“PUCCH”)) or semi-persistent CSI reporting (e.g., PUSCH or PUCCH) or aperiodic reporting (e.g., PUSCH).

Regarding Priority reporting for Part 2 CSI, note that multiple CSI reports may be transmitted, as shown in Table 1:

TABLE 1
CSI Reports priority ordering

Priority 0:
For CSI reports 1 to N_{Rep}, Group 0 CSI for CSI reports
configured as ‘typeII-r16’ or ‘typeII-PortSelection-r16’;
Part 2 wideband CSI for CSI reports configured otherwise
Priority 1:
Group 1 CSI for CSI report 1, if configured as ‘typeII-r16’
or ‘typeII-PortSelection-r16’; Part 2 subband CSI of even
subbands for CSI report 1, if configured otherwise
Priority 2:
Group 2 CSI for CSI report 1, if configured as ‘typeII-r16’
or ‘typeII-PortSelection-r16’; Part 2 subband CSI of
odd subbands for CSI report 1, if configured otherwise
Priority 3:
Group 1 CSI for CSI report 2, if configured as ‘typeII-r16’
or ‘typeII-PortSelection-r16’; Part 2 subband CSI of even
subbands for CSI report 2, if configured otherwise
Priority 4:
Group 2 CSI for CSI report 2, if configured as ‘typeII-r16’
or ‘typeII-PortSelection-r16’. Part 2 subband CSI
of odd subbands for CSI report 2, if configured otherwise
.
.
.
Priority 2N_{Rep} − 1:
Group 1 CSI for CSI report N_{Rep}, if configured as ‘typeII-r16’
or ‘typeII-PortSelection-r16’; Part 2 subband CSI of even
subbands for CSI report N_{Rep}, if configured otherwise
Priority 2N_{Rep}:
Group 2 CSI for CSI report N_{Rep}, if configured as ‘typeII-r16’
or ‘typeII-PortSelection-r16’; Part 2 subband CSI of odd
subbands for CSI report N_{Rep}, if configured otherwise

Note that the priority of the N_{Rep} CSI reports is based on a CSI report corresponding to one CSI reporting configuration for one cell may have higher priority compared with another CSI report corresponding to one other CSI reporting configuration for the same cell, CSI reports intended to one cell may have higher priority compared with other CSI reports intended to another cell, CSI reports may have higher priority based on the CSI report content, e.g., CSI reports carrying L1-RSRP information have higher priority, and CSI reports that have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower IDs have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

Regarding Triggering Aperiodic CSI Reporting on PUSCH, UE needs to report the needed CSI information for the network using the CSI framework in NR Rel. 15. The triggering mechanism between a report setting and a resource setting can be summarized in Table 2 below.

TABLE 2
Triggering mechanism between a report
setting and a resource setting

| | | Periodic CSI | SP CSI | AP CSI |
|---|---|---|---|---|
| | | reporting | reporting | Reporting |
| Time Domain | Periodic | RRC | MAC CE (PUCCH) | DCI |
| Behavior of | CSI-RS | configured | DCI (PUSCH) | |
| Resource | SP | Not | MAC CE (PUCCH) | DCI |
| Setting | CSI-RS | Supported | DCI (PUSCH) | |
| | AP | Not | Not Supported | DCI |
| | CSI-RS | Supported | | |

Moreover, in one embodiment, all associated Resource Settings for a CSI Report Setting need to have same time domain behavior, periodic CSI-RS/IM resource and CSI reports are assumed to be present and active once configured by RRC, aperiodic and semi-persistent CSI-RS/IM resources and CSI reports should be explicitly triggered or activated, joint triggering of aperiodic CSI-RS/IM resources and aperiodic CSI reports via transmitting DCI Format 0-1, and semi-persistent CSI-RS/IM resources and semi-persistent CSI reports are independently activated.

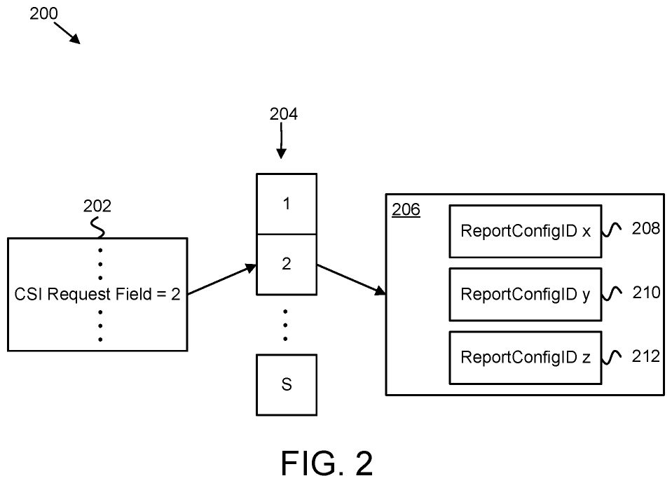

FIG. 2 illustrates an example of an aperiodic trigger state defining a list of CSI report settings that supports techniques for joint CSI training and PMI feedback for AI-enabled networks in accordance with aspects of the present disclosure. Specifically, the diagram 200 includes a DCI format 0_1 202, a CSI request codepoint 204, and an aperiodic trigger state 2 206. Moreover, the aperiodic trigger state 2 includes a ReportConfigID x 208, a ReportConfigID y 210, and a ReportConfigID z 212. For aperiodic CSI-RS/IM resources and aperiodic CSI reports, the triggering is done Jointly by transmitting a DCI Format 0-1. The DCI Format 0_1 contains a CSI request field (0 to 6 bits). A non-zero request field points to a so-called aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

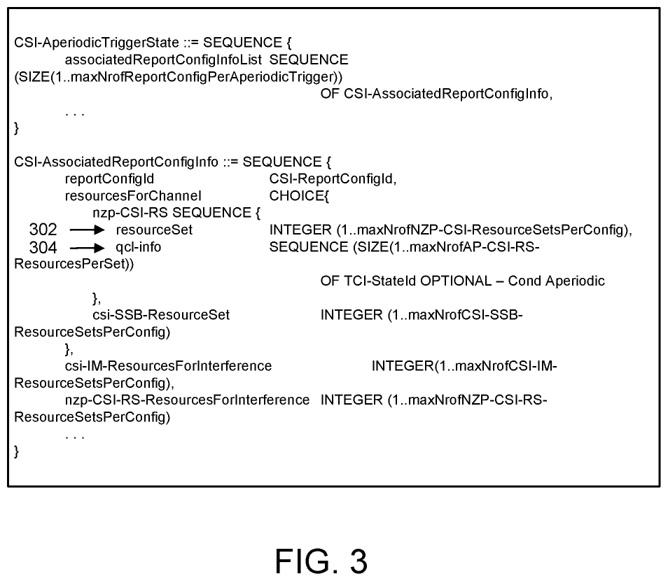

FIG. 3 illustrates an example of an aperiodic trigger state definition indicating the resource set and QCL information that supports techniques for joint CSI training and PMI feedback for AI-enabled networks in accordance with aspects of the present disclosure. In particular, FIG. 3 depicts an aperiodic trigger state that indicates the resource set 302 and QCL information 304. When the CSI Report Setting is linked with aperiodic Resource Setting (can comprise multiple Resource Sets), the aperiodic NZP-CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP-CSI-RS, the QCL source to use is also configured in the aperiodic trigger state. The UE assumes that the resources used for the computation of the channel and interference can be processed with the same spatial filter i.e., quasi-co-located with respect to “QCL-TypeD.”

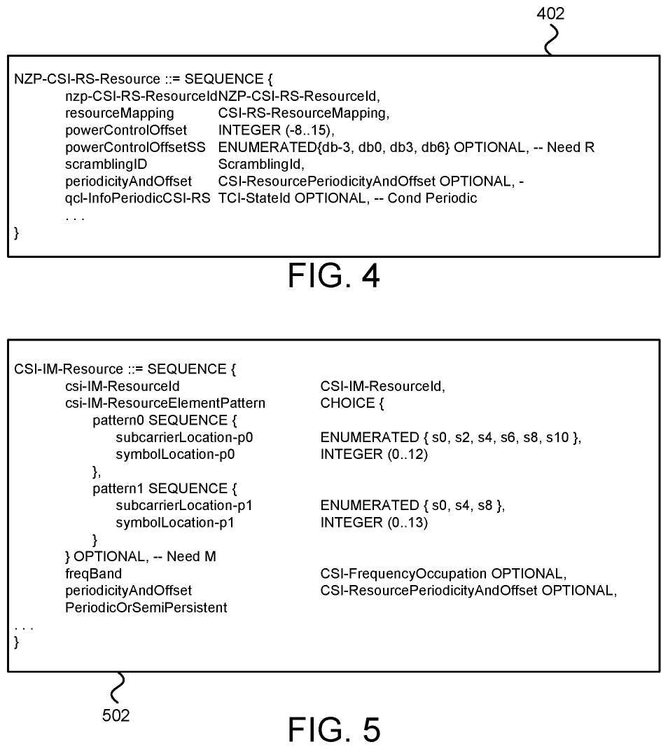

FIG. 4 illustrates an example of an RRC configuration for NZP CSI-RS resources that supports techniques for joint CSI training and PMI feedback for AI-enabled networks in accordance with aspects of the present disclosure. In particular, FIG. 4 depicts a code sample 402 illustrating one embodiment of the process by which an aperiodic trigger state indicates a resource set and QCL information.

FIG. 5 illustrates an example of an RRC configuration for CSI-IM resource that supports techniques for joint CSI training and PMI feedback for AI-enabled networks in accordance with aspects of the present disclosure. In particular, FIG. 4 depicts a code sample 502 illustrating one embodiment of an RRC configuration including a NZP-CSI-RS resource and a CSI-IM-resource.

The type of uplink channels used for CSI reporting as a function of the CSI codebook type are summarized in Table 3, below:

TABLE 3
Uplink channels used for CSI reporting
as a function of the CSI codebook type

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 2 | PUSCH |
| | | PUSCH | |
| Type II WB | | PUCCH Format 3, 4 | PUSCH |
| | | PUSCH | |
| Type II SB | | PUSCH | PUSCH |
| Type II Part | | PUCCH Format 3, 4 | |
| 1 only | | | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains RI (if reported), CRI (if reported) and CQI for the first codeword, and a number of non-zero wideband amplitude coefficients per layer for Type II CSI feedback on PUSCH.

CSI Part 2 has a variable payload size that can be derived from the CSI parameters in CSI Part 1 and contains PMI and the CQI for the second codeword when RI>4.

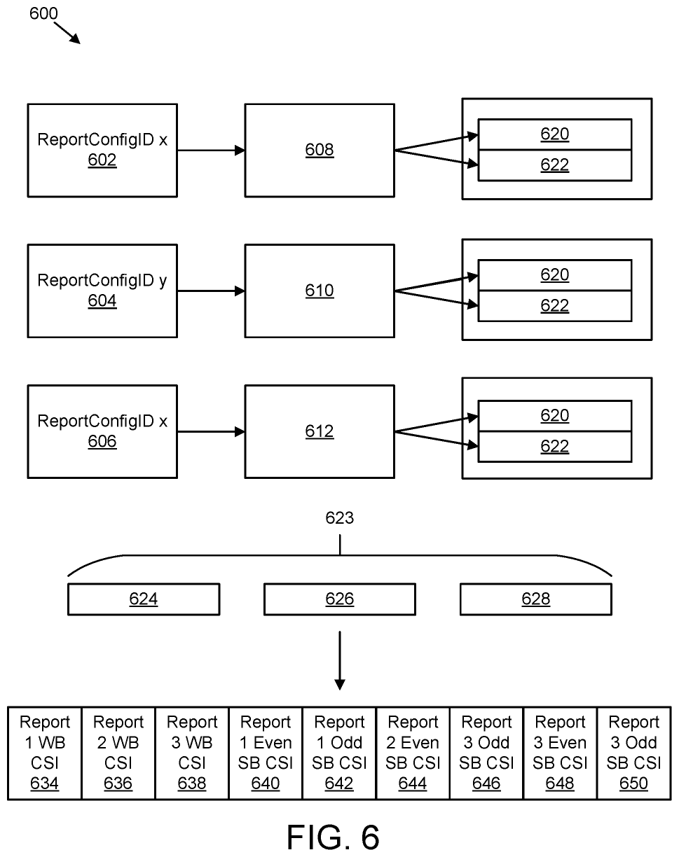

For example, if the aperiodic trigger state indicated by DCI format 0_1 defines 3 report settings x, y, and z, then the aperiodic CSI reporting for CSI part 2 will be ordered as indicated in FIG. 6.

FIG. 6 illustrates an example of a partial CSI omission for PUSCH-based CSI that supports techniques for joint CSI training and PMI feedback for AI-enabled networks in accordance with aspects of the present disclosure. In particular, FIG. 6 is a schematic block diagram 600 illustrating one embodiment of a partial CSI omission for PUSCH-based CSI. The diagram 600 includes a ReportConfigID x 602, a ReportConfigID y 604, and a ReportConfigID z 606. Moreover, the diagram 600 includes a first report 608 (e.g., requested quantities to be reported) corresponding to the ReportConfigID x 602, a second report 610 (e.g., requested quantities to be reported) corresponding to the ReportConfigID y 604, and a third report 612 (e.g., requested quantities to be reported) corresponding to the ReportConfigID z 606. Each of the first report 608, the second report 610, and the third report 612 includes a CSI part 1 620, and a CSI part 2 622. An ordering 623 of CSI part 2 across reports is CSI part 2 of the first report 624, CSI part 2 of the second report 626, and CSI part 2 of the third report 628. Moreover, the CSI part 2 reports may produce a report 1 WB CSI 634, a report 2 WB CSI 636, a report 3 WB CSI 638, a report 1 even SB CSI 640, a report 1 odd SB CSI 642, a report 2 even SB CSI 644, a report 2 odd SB CSI 646, a report 3 even SB CSI 648, and a report 3 odd SB CSI 650.

As mentioned earlier, CSI reports are prioritized according to (1) time-domain behavior and physical channel, where more dynamic reports are given precedence over less dynamic reports and PUSCH has precedence over PUCCH, (2) CSI content, where beam reports (i.e., L1-RSRP reporting) has priority over regular CSI reports, (3) the serving cell to which the CSI corresponds (in case of CA operation). CSI corresponding to the PCell has priority over CSI corresponding to Scells, and (4) the CSI Reporting Setting ID reportConfig-D.

In this disclosure, the embodiments described below are directed to a CSI feedback mechanism that aims at jointly providing CSI feedback from the network to the UE corresponding to a precoder codebook, as well as provide training data to the network. Note that the CSI reported via conventional CSI feedback schemes may not be as useful as raw CSI feedback, since the CSI feedback reported via conventional methods is compressed in either spatial domain, frequency domain, or both.

More specifically, the subject matter herein is directed to configuring the UE with feeding back a CSI report comprising CSI that corresponds to a codebook for a precoder, wherein the first subset of the CSI is reported in a compressed/transformed domain to reduce CSI feedback overhead, and wherein the second subset of the CSI is reported in an uncompressed/untransformed domain so that it can be used for AI/ML model training in addition to the codebook identification; and based on the AI/ML model inference at the network side, the network configures the UE with a selected subset of CSI compression types from a set of pre-configured CSI compression types, wherein a CSI compression type corresponds to a dimension of the PMI, e.g., spatial dimension, frequency/delay domain dimension and time/Doppler domain dimension.

Several embodiments and examples are provided to explain the proposals and clarify how they can be adopted in practical scenarios.

In general, given CSI feedback for a channel with 32 ports and 13 SB, a first step would be to transform channel with spatial DFT→New dimension is 8×13. Step 2 is to feedback 13 coefficients corresponding to the strongest beam out of the 8 beams. Step 3 is to further transform the 7 beams with a delay-domain DFT transformation 4 New dimension is 7×4. Step 4 is to feedback 28 coefficients corresponding to the weakest 7 beams.

In one embodiment, assume a channel between a UE and a gNB with P channel paths (index p=0, . . . , P−1) that occupies N_{SB} frequency bands (index n=0, . . . , N_{SB}− 1), wherein the gNB is equipped with K antennas (index k=0, . . . , K−1). The channel at a time index δ can then be represented as follows:

$${h}_{k , n} ( δ ) = {\sum }_{p = 0}^{P - 1} {g}_{k , p} {e}^{j 2 π n Δ f {τ}_{p} + j 2 π k \frac{{F}_{c} d}{c} sin {θ}_{p} + j 2 πδ \frac{{F}_{c} v}{c} cos {∅}_{p}}$$

Where g_{k,p} is the complex gain of path p at antenna k, Δf is the PMI Sub-band spacing; τₚ is the delay of path p; F_{c} is the carrier frequency; c is the speed of light; d is the antenna spacing at the gNB; θₚ is the angular spatial displacement at the gNB antenna array corresponding to path p; δ is the time index; v is the relative speed between the gNB and the UE; and Φp is the angle between the moving direction & the signal incidence direction of path p.

The channel above is parametrized by three dimensions: spatial, frequency and time dimensions. To construct a precoder codebook with reasonable CSI feedback overhead, the CSI corresponding to the three dimensions need to be compressed. In Rel. 16 Type-II codebook, both spatial and frequency domains are compressed via DFT transformation ofthe spatial and frequency domains with columns of two-dimensional and one-dimensional DFT matrices, respectively. However, the temporal variations of the channel are often ignored in codebook design due to their negligible impact at low UE speed, e.g., a small v. This approximation may not be efficient at high UE speeds, or due to fast variations of the UE orientation. Analogously, in an environment with fewer scatterers and higher UE speed, reporting CSI with respect to multiple spatial and time/Doppler domain indices may be more important than reporting the frequency/delay domain indices, since a channel with fewer scatterers is more likely to incur frequency-flat fading, e.g., channel coefficients corresponding to a common spatial domain index and a common time domain index are strongly correlated.

In this disclosure, a framework is proposed that enables joint CSI and training data feedback, wherein the training data is inherent within the CSI feedback, and wherein the training data enables the network to select a subset of one or more CSI feedback compression schemes for one or more of spatial-domain dimension, frequency/delay-domain dimension, or time/Doppler-domain dimension, from a set of pre-configured CSI feedback schemes. Several embodiments are described below that provide a CSI feedback framework that enables joint CSI and training data feedback, and additionally enables the network to select CSI feedback compression scheme(s) for one or more spatial-domain dimension, frequency/delay-domain dimension, or time/Doppler-domain dimension, from a set of pre-configured CSI feedback schemes. According to a possible embodiment, one or more elements or features from one or more of the described embodiments may be combined.

In a first embodiment, for AI/ML-based CSI frameworks, multiple alternatives exist for the outline of the AI/ML algorithm functionality. In one embodiment, the AI/ML model is trained at the UE node. This alternative may appear reasonable since the UE is the node that can seamlessly collect training data for CSI acquisition using DL pilot signals, e.g., CSI-RSs for channel measurement, however, the memory and computational complexity requirements for this operation would be massive, since a new AI/ML model should be re-trained whenever the environment change, e.g., change of the UE location/orientation.

In another embodiment, the AI/ML model is trained at the network node. One advantage of this approach is that the network has significantly more power and computational capabilities compared with a UE node, and hence can manage training moderately complex AI/ML models, as well as store large amounts of training data. Moreover, since a network node is mostly assumed to be fixed, its coverage area is expected to be the same and hence a same AI/ML model can be applicable to UEs within a specific region of the cell for a reasonable period of time. The one challenge with this approach is related to obtaining the training data at the network node, especially for FDD systems in which the UL/DL channel reciprocity may not hold. Note that the overhead corresponding to feeding back the training data from the UE to the network should be considered as one of the metrics when assessing the efficiency of an AI/ML algorithm.

In the sequel, it is assumed that the AI/ML model is trained at the network due to the advantages corresponding to memory, computation, and cell-centric characteristics of the network-based AI/ML model computation. The challenge corresponding to obtaining the training data corresponding to the DL channel at the network side is discussed in the next section.

Assuming that the AI/ML model is trained at the network, a few aspects of DL training data acquisition at the network side are discussed to enable efficient AI/ML modeling. In one embodiment, to maintain the robustness of the AI/ML model with respect to channel variations, DL training data should be continuously fed back to the network to keep up with changes in the environment, e.g., traffic, weather, and mobile scatterers. Note that this may not necessarily correspond to online learning; even for an offline learning algorithm a framework for obtaining new training data corresponding to channel variations should be characterized.

In another embodiment, based on the current codebook-based DL CSI feedback schemes in NR, the CSI is compressed in at least one of the spatial domain, or the frequency domain, or both. One intuitive approach would be using the codebook-based CSI feedback, e.g., Type-I and/or Type-II codebooks for obtaining the training data. One disadvantage of this approach is that the training data would comprise CSI feedback that is already compressed via conventional approaches, which would have detrimental effect on the AI/ML model inference accuracy. For instance, if the AI/ML model compares the output of the AI/ML model with the channel corresponding to the CSI feedback to assess the AI/ML model inference accuracy, this assessment would not be precise since it is based on H′, an estimate of the channel based on a pre-defined compression, rather than H, a digitally quantized channel without further compression in spatial domain, or frequency domain. On the other hand, if the UE feeds back the training data corresponding to the DL CSI feedback without compression over spatial and/or frequency dimensions, the feedback overhead of the training data would be significant, which would beat the purpose of using the AI/ML model, which is mainly to reduce the overall CSI feedback overhead.

Numerically, an AI/ML-based CSI feedback aims at minimizing the following metric:

$${min}_{\hat{H}} ‖ \hat{H} - H ‖$$

Wherein H represents a digital-domain representation of the channel matrix. On the other hand, a compressed channel H′, which represents the recovered channel after codebook-based transformation, would yield the following optimization metric:

$${min}_{\hat{H}} ‖ \hat{H} - {H}^{′} ‖$$

Since H≠H′, the output of both optimizations would yield different channel estimates. In the sequel, we propose a new approach that aims at balancing between the training data quality and its corresponding feedback overhead.

In one embodiment, for DL CSI acquisition in NR, whether the network operates in FDD mode or time division duplex (“TDD”) mode, it is unlikely that AI/ML would fully replace RS-based CSI feedback for high-resolution precoding design, since some channel parameters may vary from one time instant to another, without strong correlation across the two time instants, e.g., initial random phases of the channel. Given that, an AI/ML-based CSI framework can be envisioned as means of further reducing the CSI feedback overhead compared with conventional methods, e.g., reduce the number of dominant spatial-domain basis indices, frequency/delay-domain basis indices, and time/Doppler-domain basis indices, after spatial domain transformation, frequency-domain transformation, and time-domain transformation, respectively. While current CSI feedback frameworks already provide CSI feedback overhead reduction via exploiting such transformations, the CSI dimensionality can be further reduced if a wider range of transformation techniques are pre-configured, wherein a different transformation may be selected for a given UE based on variations of the channel.

In this section, a CSI feedback framework approach is proposed that enables simultaneous codebook reporting and training data feedback from the UE to the network. Under this framework, the UE is configured with a CSI reporting configuration that comprises reporting a codebook corresponding to PMI, wherein a subset of the PMI is used as CSI training data. Note that this subset of the PMI can be used for both precoder identification as well as training data. To make this subset of the PMI useful for both purposes, it is reported with distinct characteristics compared with those of the remainder of the PMI. To elaborate more on these characteristics, two alternative NR codebook designs are reviewed, wherein the network node is equipped with a two-dimensional (2D) antenna array with N₁, N₂ antenna ports per polarization placed horizontally and vertically, respectively, and communication occurs over N₃ sub-bands.

In codebook design 1 related to spatial domain CSI compression, a first design of the PMI codebook for a given layer is as follows:

W=W₁W₂

Under this design, the codebook W comprises a spatial-domain transformation matrix W₁ of size 2N₁N₂×2L that transforms the 2N₁N₂ dimensional spatial domain to a transformed spatial domain with 2L dimensions, where L≤N₁N₂, and the matrix W₂ of size 2L×N₃ comprises the linear combination coefficients of the codebook whose rows and columns correspond to the transformed spatial domain indices and the frequency domain indices, respectively. Note that this design resembles Rel. 15 Type-II codebook, which only compresses the spatial domain of the codebook.

In codebook design 2 related to frequency domain CSI compression, a second design of the PMI codebook for a given layer is as follows:

W=Ŵ₂W_{f}^{H}

Under this design, the codebook W comprises a frequency-domain transformation matrix W_{f} of size N₃×M, which transforms the N₃ dimensional frequency domain to a transformed frequency domain with M dimensions, where M≤N₃, and the matrix Ŵ₂ of size 2N₁N₂×M comprises the linear combination coefficients of the codebook whose rows and columns correspond to the spatial domain indices and the transformed frequency domain indices, respectively. More generally, that matrix W_{f} may correspond to a frequency domain transformation, a time/Doppler domain transformation, or a combination thereof.

In codebook design 3 related to joint spatial and frequency domain CSI compression, a third design of the PMI codebook for a given layer is as follows:

W=W₁\tilde{W}₂W_{f}^{H}

Under this design, the codebook W comprises a spatial-domain transformation matrix W₁ of size 2N₁N₂×2L that applies spatial-domain transformation, similar to Design 1. Additionally, a second transformation matrix W_{f} of size N₃×M is applied that applies frequency-domain transformation, similar to codebook design 2. The matrix W₂ of size 2L×M comprises the linear combination coefficients of the codebook whose rows and columns correspond to the transformed spatial domain indices and the transformed frequency domain indices, respectively. More generally, that matrix W_{f} may correspond to a frequency domain transformation, a time/Doppler domain transformation, or a combination thereof.

Several embodiments that describe the channel transformation over at least one of the transformed spatial-domain dimension, the transformed frequency/delay-domain dimension and the transformed time/Doppler-domain dimension are provided below. According to a possible embodiment, one or more elements or features from one or more of the described embodiments may be combined.

In a first embodiment, the set of non-zero channel coefficients corresponding to a PMI codebook are decomposed to two subsets of channel coefficients, wherein coefficients corresponding to a first of the two subsets of channel coefficients are associated with a first set of indices of a first dimension of the PMI, and wherein a second of the two subsets of channel coefficients are associated with a second set of indices of a first dimension of the PMI.

In a first example, the first dimension of the PMI corresponds to the transformed spatial domain, wherein the two subsets of channel coefficients are associated with different sets of index values corresponding to the transformed spatial domain indices.

In a second example, the first dimension of the PMI corresponds to the transformed frequency/delay domain, wherein the two subsets of channel coefficients are associated with different sets of index values corresponding to the transformed frequency/delay domain indices.

In a third example, the first dimension of the PMI corresponds to the transformed time/Doppler domain, wherein the two subsets of channel coefficients are associated with different sets of index values corresponding to the transformed time/Doppler domain indices.

In a fourth example, the first dimension of the PMI corresponds to a joint domain corresponding to the transformed frequency/delay domain and the transformed time/Doppler domain, wherein the two subsets of channel coefficients are associated with different sets of index values corresponding to the joint transformed frequency/delay domain and transformed time/Doppler domain indices.

In a fifth example, the first subset of channel coefficients corresponds to a first codebook design, e.g., Codebook Design 1, and the second subset of channel coefficients corresponds to a second codebook design, e.g., Codebook Design 2. Alternatively, the first subset of channel coefficients corresponds to Codebook Design 2, and the second subset of channel coefficients corresponds to Codebook Design 3.

In a second embodiment, the first set of indices of the first dimension of the PMI is disjoint with respect to the second set of indices of the first dimension of the PMI. In a first example, the first set of indices of the first dimension of the PMI comprises a single index, e.g., the index corresponding to the largest power, or channel gain, and the second set of indices of the first dimension of the PMI comprises the remainder of select indices, i.e., all selected indices other than the index corresponding to the first set of indices.

In a third embodiment, the first of the two subsets of non-zero channel coefficients correspond to a first transformation of the first dimension of the PMI, and the second of the two subsets of non-zero coefficients correspond to a second transformation of the first dimension of the PMI.

In a first example, the first transformation is a trivial transformation, e.g., a scaling of the coefficients corresponding to the first set of indices.

In a second example, the first transformation corresponds to an averaging process of the channel coefficients corresponding to the first set of indices.

In a third example, the first transformation corresponds to a selection of the channel coefficients corresponding to the first set of indices, e.g., a selection of even-numbered indices, or a selection of odd-numbered indices.

In a fourth example, the second transformation corresponds to a DFT matrix transformation.

In a fifth example, the second transformation corresponds to a Discrete Wavelet Transform (“DWT”) matrix transformation.

In a sixth example, the second transformation corresponds to a Discrete Sine/Cosine Transform (“DST”/“DCT”) matrix transformation.

As discussed in the previous section, the CSI feedback is classified into two parts, based on whether the CSI feedback corresponds to training-based CSI feedback or PMI-based CSI feedback. Given that, the training-based CSI feedback corresponding to the first of the two subsets of channel coefficients, may aid the network in selecting the best transformation/compression approach for the PMI-based CSI feedback corresponding to the second of the two subsets of channel coefficients. Several embodiments are described below. According to a possible embodiment, one or more elements or features from one or more of the described embodiments may be combined.

In a first embodiment, the training-based CSI feedback comprises a larger number of coefficients per dimension compared with the PMI-based CSI feedback.

In a second embodiment, coefficients corresponding to the training-based CSI feedback are quantized using scalar quantization, e.g., each of the amplitude value and the phase value corresponding to a given coefficient is encoded separately. In one example, the coefficients corresponding to training-based CSI feedback are quantized with a higher resolution compared with PMI-based CSI feedback, e.g., coefficients corresponding to training-based CSI feedback are quantized with a larger number of bits compared with coefficients corresponding to PMI-based CSI feedback.

In a third embodiment, coefficients corresponding to the PMI-based CSI feedback are quantized with a codebook from a set of pre-configured codebooks. In one example, the set of pre-configured codebooks comprises one of a codebook with amplitude values distributed uniformly in a linear domain, and a codebook with amplitude values distributed uniformly in a logarithmic domain.

In a fourth embodiment, coefficients corresponding to the PMI-based CSI feedback are quantized using vector quantization, e.g., amplitude values corresponding to two coefficients, or phase values corresponding to two coefficients, or some combination thereof, and encoded jointly.

In a fifth embodiment, a UE that is configured with training-based CSI feedback is also expected to be configured with a CSI domain transformation over one or more of spatial domain, frequency domain, or time domain corresponding to the PMI-based CSI feedback based on the training-based CSI feedback. In a first example, the CSI reporting setting received at the UE comprises a configuration parameter that configures the UE with a transformation scheme from a set of pre-configured transformation schemes corresponding to at least one CSI dimension.

In a second example, the set of pre-configured transformation schemes comprise one or more of a DFT scheme, a DCT, a DST, a DWT, a basic averaging transformation, a weighted averaging transformation, or some combination thereof.

For a transformation matrix that transforms one dimension of the channel from N indices to N′ indices, and N′≤N, the following examples are provided:

Example 1: one-dimensional DFT matrix transformation:

$${f}_{k} = [ \begin{matrix}1 & {e}^{- j \frac{2 π k}{N}} & … & {{e}^{- j \frac{2 π k ( N - 1 )}{N}} ]}^{T} , 0 \leq k \leq N - 1\end{matrix}$$

$${W}_{f} = [ \begin{matrix}{f}_{{k}_{0}} & {f}_{{k}_{1}} & … & {f}_{{k}_{{N}^{′} - 1}} ]\end{matrix} , 0 \leq {k}_{i} \leq N - 1$$

Example 2: one-dimensional DCT matrix transformation:

$${f}_{k} = \sqrt{\frac{1 + ⌈ \frac{k}{N} ⌉}{N}} \cdot [ \begin{matrix}cos \frac{k π}{2 N} & cos \frac{3 k π}{2 N} & … & {cos \frac{( 2 N - 1 ) k π}{2 N} ]}^{T} , 0 \leq k \leq N - 1\end{matrix}$$

$${W}_{f} = [ \begin{matrix}{f}_{{k}_{0}} & {f}_{{k}_{1}} & … & {f}_{{k}_{{N}^{′} - 1}} ]\end{matrix} , 0 \leq {k}_{i} \leq N - 1$$

Example 3: one-dimensional DST matrix transformation:

$${f}_{k} = \sqrt{\frac{1 + ⌈ \frac{k}{{N}_{3}} ⌉}{N}} \cdot [ \begin{matrix}sin \frac{k π}{2 N} & sin \frac{3 k π}{2 N} & … & {sin \frac{( 2 N - 1 ) k π}{2 N} ]}^{T} , 0 \leq k \leq N - 1\end{matrix}$$

$${W}_{f} = [ \begin{matrix}{f}_{{k}_{0}} & {f}_{{k}_{1}} & … & {f}_{{k}_{{N}^{′} - 1}} ]\end{matrix} , 0 \leq {k}_{i} \leq N - 1$$

Example 4: one-dimensional Haar matrix transformation:

$${F}_{2} = [ \begin{matrix}1 & 1 \\ 1 & - 1\end{matrix} ]$$

$${F}_{N} = [ \begin{matrix}{F}_{N / 2} ⊗ [ \begin{matrix}1 & 1\end{matrix} ] \\ {I}_{N / 2} ⊗ [ \begin{matrix}1 & - 1\end{matrix} ]\end{matrix} ] = [ \begin{matrix}{f}_{0} & ... & {f}_{N - 1}\end{matrix} ] , N > 2$$

$${W}_{f} = [ \begin{matrix}{f}_{{k}_{0}} & {f}_{{k}_{1}} & … & {f}_{{k}_{{N}^{′} - 1}} ]\end{matrix} , 0 \leq {k}_{i} \leq N - 1$$

Wherein Iₛ corresponds to an identity matrix of size s, and the operator ⊗ is the Kronecker product.

For a transformation matrix that transforms two dimensions, e.g., joint time/Doppler domain and frequency domain, the following examples are provided:

Example 1: two-dimensional DFT matrix transformation:

$${f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T} , 0 \leq k \leq {N}_{3} - 1\end{matrix}$$

$${z}_{δ , k} = {[ \begin{matrix}{f}_{k}^{T} & {e}^{j \frac{2 π δ}{{N}_{4}}} {f}_{k}^{T} & … & {e}^{j \frac{2 πδ}{{N}_{4}}} {f}_{k}^{T} & … & {e}^{j \frac{2 π δ ( {N}_{4} - 1 )}{{N}_{4}}} {f}_{k}^{T}\end{matrix} ]}^{T} , 0 \leq δ \leq {N}_{4} - 1$$

$${W}_{f} = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {N}_{3} - 1 , 0 \leq {δ}_{i} \leq {N}_{4} - 1$$

Example 2: two-dimensional DCT matrix transformation:

$${f}_{k} = \sqrt{\frac{1 + ⌈ \frac{k}{{N}_{3}} ⌉}{{N}_{3}}} \cdot [ \begin{matrix}cos \frac{k π}{2 {N}_{3}} & cos \frac{3 k π}{2 {N}_{3}} & … & {cos \frac{( 2 {N}_{3} - 1 ) k π}{2 {N}_{3}} ]}^{T} , 0 \leq k \leq {N}_{3} - 1\end{matrix}$$

$${z}_{δ , k} = \sqrt{\frac{1 + ⌈ \frac{δ}{{N}_{4}} ⌉}{{N}_{4}}} \cdot [ \begin{matrix}cos \frac{δ π}{2 {N}_{4}} \cdot {f}_{k}^{T} & cos \frac{3 δ π}{2 {N}_{4}} \cdot {f}_{k}^{T} & … & {cos \frac{( 2 {N}_{4} - 1 ) δ π}{2 {N}_{4}} \cdot {f}_{k}^{T} ]}^{T} , 0 \leq δ \leq {N}_{4} - 1\end{matrix}$$

$${W}_{f} = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {N}_{3} - 1 , 0 \leq {δ}_{i} \leq {N}_{4} - 1$$

Example 3: two-dimensional DST matrix transformation:

$${f}_{k} = \sqrt{\frac{1 + ⌈ \frac{k}{{N}_{3}} ⌉}{{N}_{3}}} \cdot [ \begin{matrix}sin \frac{k π}{2 {N}_{3}} & sin \frac{3 k π}{2 {N}_{3}} & … & {sin \frac{( 2 {N}_{3} - 1 ) k π}{2 {N}_{3}} ]}^{T} , 0 \leq k \leq {N}_{3} - 1\end{matrix}$$

$${z}_{δ , k} = \sqrt{\frac{1 + ⌈ \frac{δ}{{N}_{4}} ⌉}{{N}_{4}}} \cdot [ \begin{matrix}sin \frac{δ π}{2 {N}_{4}} \cdot {f}_{k}^{T} & sin \frac{3 δ π}{2 {N}_{4}} \cdot {f}_{k}^{T} & … & {sin \frac{( 2 {N}_{4} - 1 ) δ π}{2 {N}_{4}} \cdot {f}_{k}^{T} ]}^{T} , 0 \leq δ \leq {N}_{4} - 1\end{matrix}$$

$${W}_{f} = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {N}_{3} - 1 , 0 \leq {δ}_{i} \leq {N}_{4} - 1$$

In a sixth embodiment, a parameter corresponding to indices of a selected subset of basis vectors of a domain transformation matrix is communicated between the UE and the network. In a first example, the parameter is fed back from the UE to the network as part of the CSI report. In a second example, the parameter is higher-layer configured from the network to the UE. In a third example, the parameter is represented as a combinatorial value, e.g., a selection of k basis vectors from a set of N basis vectors, where k≤N, is represented via └log₂ Cₖ^{N}/┘ bits, wherein

$${C}_{k}^{N} {=}^{Δ} \frac{N !}{( N - k ) ! \cdot k !} ,$$

and k! [symbol] k(k-1)(k-2)× . . . ×2×1, and └a┘ corresponds to a the smallest integer value that is larger than or equal to the variable a, e.g., a ceiling function.

Different embodiments that discuss the content and configuration of a CSI Report are presented. Note that combinations of the elements of one or more embodiments are not precluded.

In a first embodiment, the CSI report corresponding to the mixed joint training data and PMI feedback is configured via CSI reporting configuration with one or more of the following quantities: ‘CRI’, ‘RI’, ‘PMI’, ‘CQI’, ‘LI’, ‘SSBRI’, ‘L1-SINR’, ‘L1-RSRP’. One or more additional quantities, e.g., ‘TDI’, corresponding to training data indication, may also be configured.

In a second embodiment, the CSI report corresponding to the mixed joint training data and PMI feedback includes location information of the UE. In a first example a CSI feedback report corresponding to one codebook includes a differential location information with respect to the location of the UE at the instant of the last CSI feedback report corresponding to a prior codebook transmission. In a second example, reporting the location information is based on a higher-layer configuration within the CSI reporting configuration.

In a third embodiment, the CSI report corresponding to the mixed joint training data and PMI feedback comprises a bitmap indicating the indices of non-zero coefficients, and wherein coefficients corresponding to training-based CSI feedback are not included in the bitmap. In one example, coefficients corresponding to the training-based CSI feedback are always reported.

In a fourth embodiment, the CSI reporting configuration corresponding to the mixed joint training data and PMI feedback comprises a higher-layer parameter that enables and disables the inclusion of training-based CSI feedback corresponding to the first of the two subsets of channel coefficients.

Regarding antenna Panel/Port, Quasi-collocation, TCI state, Spatial Relation, in some embodiments, the terms antenna, panel, and antenna panel are used interchangeably. An antenna panel may be a hardware that is used for transmitting and/or receiving radio signals at frequencies lower than 6 GHz, e.g., FR1, or higher than 6 GHz, e.g., FR2 or mmWave. In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one ofthe following values: ‘QCL-TypeA’: {Doppler shift, Doppler spread, average delay, delay spread}, ‘QCL-TypeB’: {Doppler shift, Doppler spread}, ‘QCL-TypeC’: {Doppler shift, average delay}, and/or ‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e., the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the embodiments described, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the embodiments described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

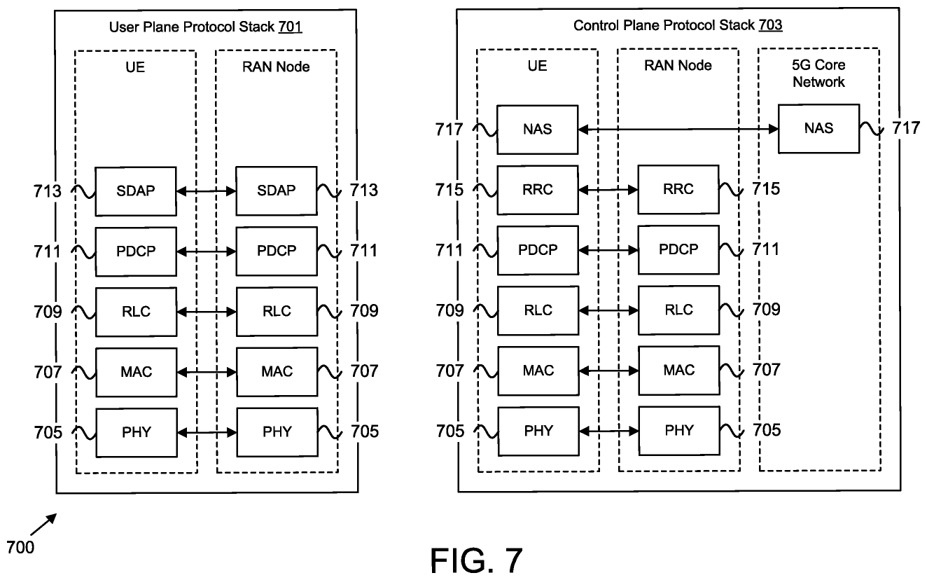

FIG. 7 illustrates an example of an NRprotocol stack 700 that supports techniques for joint CSI training and PMI feedback for AI-enabled networks in accordance with aspects of the present disclosure. While FIG. 7 shows a UE, a RAN node and a 5G core network, these are representative of a set of remote units 105 interacting with a base unit 121 and a mobile core network 140. As depicted, the protocol stack 700 comprises a User Plane protocol stack 701 and a Control Plane protocol stack 703. The User Plane protocol stack 701 includes a physical (“PHY”) layer 705, a Medium Access Control (“MAC”) sublayer 707, the Radio Link Control (“RLC”) sublayer 709, a Packet Data Convergence Protocol (“PDCP”) sublayer 711, and Service Data Adaptation Protocol (“SDAP”) layer 713. The Control Plane protocol stack 703 includes a physical layer 705, a MAC sublayer 707, a RLC sublayer 709, and a PDCP sublayer 711. The Control Place protocol stack 703 also includes an RRC layer 715 and a Non-Access Stratum (“NAS”) layer 717.

The AS layer (also referred to as “AS protocol stack”) for the User Plane protocol stack 701 consists of at least SDAP, PDCP, RLC and MAC sublayers, and the physical layer. The AS layer for the Control Plane protocol stack 703 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 715 and the NAS layer 717 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The physical layer 705 offers transport channels to the MAC sublayer 707. The MAC sublayer 707 offers logical channels to the RLC sublayer 709. The RLC sublayer 709 offers RLC channels to the PDCP sublayer 711. The PDCP sublayer 711 offers radio bearers to the SDAP sublayer 713 and/or RRC layer 715. The SDAP sublayer 713 offers QoS flows to the core network (e.g., 5GC). The RRC layer 715 provides for the addition, modification, and release of Carrier Aggregation and/or Dual Connectivity. The RRC layer 715 also manages the establishment, configuration, maintenance, and release of Signaling Radio Bearers (“SRBs”) and Data Radio Bearers (“DRBs”).

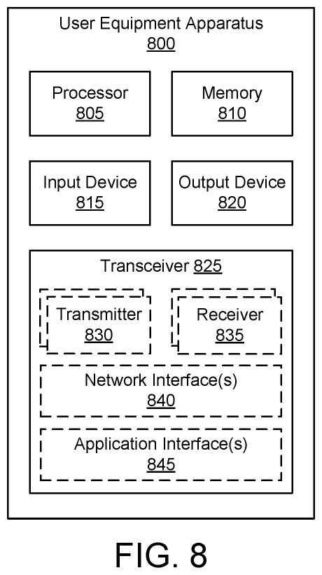

FIG. 8 illustrates an example of a UE apparatus 800 that supports techniques for joint CSI training and PMI feedback for AI-enabled networks in accordance with aspects of the present disclosure. In various embodiments, the UE apparatus 800 is used to implement one or more of the solutions described above. The UE apparatus 800 may be one embodiment of a UE, such as the remote unit 105 and/or the UE 805, as described above. Furthermore, the UE apparatus 800 may include a processor 805, a memory 810, an input device 815, an output device 820, and a transceiver 825. In some embodiments, the input device 815 and the output device 820 are combined into a single device, such as a touchscreen. In certain embodiments, the UE apparatus 800 may not include any input device 815 and/or output device 820. In various embodiments, the UE apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more base units 121. Additionally, the transceiver 825 may support at least one network interface 840 and/or application interface 845. The application interface(s) 845 may support one or more APIs. The network interface(s) 840 may support 3GPP reference points, such as Uu and PC5. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the UE apparatus 800 to implement the above-described UE behaviors for techniques for joint CSI training and PMI feedback for AI-enabled networks.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to techniques for joint CSI training and PMI feedback for AI-enabled networks. For example, the memory 810 may store UL, DL and/or SL resource configurations, measurement configuration, UE configurations, beam management states, and the like. In certain embodiments, the memory 810 also stores program code and related data, such as an operating system or other controller algorithms operating on the remote unit 135.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the UE apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all, or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. The transceiver 825 may be used to provide UL communication signals to a base unit 121 and to receive DL communication signals from the base unit 121, as described herein. Similarly, the transceiver 825 may be used to transmit and receive SL signals (e.g., V2X communication), as described herein. Although only one transmitter 830 and one receiver 835 are illustrated, the UE apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an ASIC, or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

In one embodiment, the memory 810 includes instructions that are executable by the processor 805 to cause the apparatus 800 to receive, based on a CSI reporting setting, a set of RSs for channel measurement corresponding to an NZP CSI-RS resource, generate a CSI report, based on the channel measurement, that comprises precoding matrix information for a precoding matrix and a set of coefficients that correspond to at least one dimension of the precoding matrix, and transmit the CSI report.

In one embodiment, the precoding matrix comprises a first basis transformation associated with a first dimension of the at least one dimension of the precoding matrix and the set of coefficients correspond to the precoding matrix decomposed to two subsets of coefficients corresponding to different indices of the first dimension of the precoding matrix.

In one embodiment, a first subset of the two subsets of coefficients that are associated with a second basis transformation are associated with a second dimension of the precoding matrix, and a second subset of the two subsets of coefficients that are associated with a third basis transformation are associated with the second dimension of the precoding matrix.

In one embodiment, the instructions are executable by the processor 805 to cause the apparatus 800 to receive, from the network, the CSI reporting setting for configuring the UE for at least one of channel measurement and reporting.

In one embodiment, the NZP CSI-RS resource comprises a plurality of CSI-RS ports.

In one embodiment, the third basis transformation transforms the second dimension of the precoding matrix from a domain comprising the plurality of CSI-RS ports to a domain comprising one or more spatial beams.

In one embodiment, the instructions are executable by the processor 805 to cause the apparatus 800 to transform, based on the first basis transformation, the first dimension of the precoding matrix from a domain comprising the plurality of CSI-RS ports to a domain comprising one or more spatial beams.

In one embodiment, the second basis transformation comprises at least one of an averaging over multiple indices of the second dimension into a lesser number of indices corresponding to the second dimension, a one-to-one transformation to a same number of indices corresponding to the second dimension, and a selection of a subset of indices from a set of indices corresponding to the second dimension.

In one embodiment, the second basis transformation comprises a selection of one of even-numbered indices or odd-numbered indices corresponding to the second dimension.

In one embodiment, the second basis transformation corresponds to a same type of the third basis transformation, the third basis transformation transforming the second dimension into a lesser number of indices than the second basis transformation.

In one embodiment, the third basis transformation corresponds to at least one of a transformation of the second dimension of the precoding matrix from a domain comprising a plurality of channel's frequency sub-bands to a domain comprising a transformed frequency domain basis and a transformation of the second dimension of the precoding matrix from a domain comprising a plurality of channel's time units to a domain comprising a transformed time domain basis.

In one embodiment, the first basis transformation corresponds to transforms the first dimension of the precoding matrix from at least one of a transformation of the first dimension of the precoding matrix from a domain comprising a plurality of channel's frequency sub-bands to a domain comprising a transformed frequency domain basis and a transformation of the first dimension of the precoding matrix from a domain comprising a plurality of channel's time units to a domain comprising a transformed time domain basis.

In one embodiment, the instructions are executable by the processor 805 to cause the apparatus 800 to represent the coefficients associated with the first subset of coefficients with a distinct codebook of quantized values as compared with coefficients associated with the second subset of coefficients.

In one embodiment, the instructions are executable by the processor 805 to cause the apparatus 800 to separately quantize a coefficient associated with the first subset of coefficients for each of an amplitude component and a phase component of the coefficient.

In one embodiment, the instructions are executable by the processor 805 to cause the apparatus 800 to jointly quantize a coefficient associated with the second subset of coefficients for both of an amplitude component and a phase component of the coefficient.

In one embodiment, the instructions are executable by the processor 805 to cause the apparatus 800 to jointly quantize a plurality of coefficients associated with the second subset of coefficients for at least one of amplitude components and phase components.

In one embodiment, a number of bits associated with quantizing a coefficient associated with the first subset of coefficients is larger than a number of bits associated with quantizing a coefficient associated with the second subset of coefficients.

In one embodiment, the instructions are executable by the processor 805 to cause the apparatus 800 to represent coefficients associated with the second subset of coefficients with a codebook from a set of pre-configured codebooks.

In one embodiment, the set of pre-configured codebooks comprises at least one of a codebook with amplitude values distributed uniformly in a linear domain and a codebook with amplitude values distributed uniformly in a logarithmic domain.

In one embodiment, the instructions are executable by the processor 805 to cause the apparatus 800 to configure the third basis transformation associated with the second subset of coefficients from a set of pre-configured transformation methods.

In one embodiment, the set of pre-configured transformation methods comprises at least one of a discrete Fourier transformation, a discrete cosine transformation, a discrete sine transformation, a discrete wavelet transformation, and a Haar transformation.

In one embodiment, the instructions are executable by the processor 805 to cause the apparatus 800 to feed back indices corresponding to vectors of a transformation matrix corresponding to the third transformation in the CSI report.

In one embodiment, indices corresponding to vectors of a transformation matrix corresponding to the third transformation are configured by the network via a higher-layer configuration.

In one embodiment, the instructions are executable by the processor 805 to cause the apparatus 800 to configure the UE with reporting a report quantity corresponding to a training indicator.

In one embodiment, the CSI report comprises location information corresponding to a location of the UE.

In one embodiment, the CSI report comprises a bitmap indicating indices of non-zero coefficients, and wherein coefficients corresponding to the first subset of channel coefficients are excluded from the bitmap.

In one embodiment, coefficients corresponding to the first subset of the two subsets of channel coefficients are always reported in the CSI report.

In one embodiment, the instructions are executable by the processor 805 to cause the apparatus 800 to configure the UE with a higher-layer parameter within the CSI reporting setting that enables or disables reporting the first subset of the two subsets of coefficients.

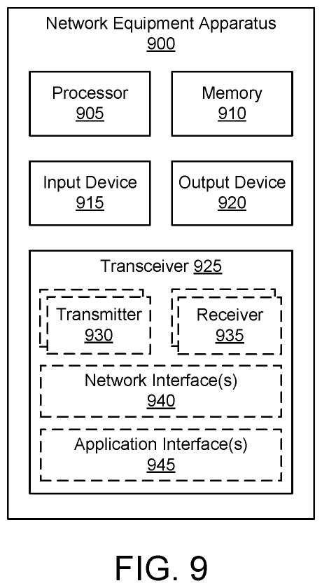

FIG. 9 illustrates an example of an NE apparatus 900 that supports techniques for joint CSI training and PMI feedback for AI-enabled networks in accordance with aspects of the present disclosure. In some embodiments, the NE apparatus 900 may be one embodiment of a RAN node and its supporting hardware, such as the base unit 121 and/or gNB, described above. Furthermore, NE apparatus 900 may include a processor 905, a memory 910, an input device 915, an output device 920, and a transceiver 925. In certain embodiments, the NE apparatus 900 does not include any input device 915 and/or output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2 and N3 interfaces. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, an FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the processor 905 controls the NE apparatus 900 to implement the above-described network entity behaviors (e.g., ofthe gNB) for techniques for joint CSI training and PMI feedback for AI-enabled networks.

The memory 910, in one embodiment, is a computer readable storage medium. In some embodiments, the memory 910 includes volatile computer storage media. For example, the memory 910 may include a RAM, including DRAM, SDRAM, and/or SRAM. In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data relating to techniques for joint CSI training and PMI feedback for AI-enabled networks. For example, the memory 910 may store UL, DL and/or SL resource configurations, measurement configuration, UE configurations, beam management states, and the like. In certain embodiments, the memory 910 also stores program code and related data, such as an operating system (“OS”) or other controller algorithms operating on the NE apparatus 900 and one or more software applications.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, may include any known electronically controllable display or display device. The output device 920 may be designed to output visual, audible, and/or haptic signals. In some embodiments, the output device 920 includes an electronic display capable of outputting visual data to a user. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all, or portions of the output device 920 may be integrated with the input device 915. For example, the input device 915 and output device 920 may form a touchscreen or similar touch-sensitive display. In other embodiments, all, or portions of the output device 920 may be located near the input device 915.

As discussed above, the transceiver 925 may communicate with one or more remote units and/or with one or more interworking functions that provide access to one or more PLMNs. The transceiver 925 may also communicate with one or more network functions (e.g., in the mobile core network 140). The transceiver 925 operates under the control of the processor 905 to transmit messages, data, and other signals and also to receive messages, data, and other signals. For example, the processor 905 may selectively activate the transceiver (or portions thereof) at particular times in order to send and receive messages.

The transceiver 925 may include one or more transmitters 930 and one or more receivers 935. In certain embodiments, the one or more transmitters 930 and/or the one or more receivers 935 may share transceiver hardware and/or circuitry. For example, the one or more transmitters 930 and/or the one or more receivers 935 may share antenna(s), antenna tuner(s), amplifier(s), filter(s), oscillator(s), mixer(s), modulator/demodulator(s), power supply, and the like. In one embodiment, the transceiver 925 implements multiple logical transceivers using different communication protocols or protocol stacks, while using common physical hardware.

In one embodiment, the memory 910 includes instructions that are executable by the processor 905 to transmit, to a UE, a CSI reporting setting for configuring the UE for at least one of channel measurement and reporting, transmit, to the UE, a set of RSs for channel measurement corresponding to an NZP CSI-RS resource, and receive, from the UE, a CSI report. In one embodiment, the CSI report includes precoding matrix information for a precoding matrix and a set of coefficients that correspond to at least one dimension of the precoding matrix, the precoding matrix comprising a first basis transformation associated with a first dimension of the at least one dimension of the precoding matrix, the set of coefficients corresponding to the precoding matrix decomposed to two subsets of coefficients corresponding to different indices of the first dimension of the precoding matrix, a first subset of the two subsets of coefficients associated with a second basis transformation associated with a second dimension of the precoding matrix, and a second subset of the two subsets of coefficients associated with a third basis transformation associated with the second dimension of the precoding matrix.

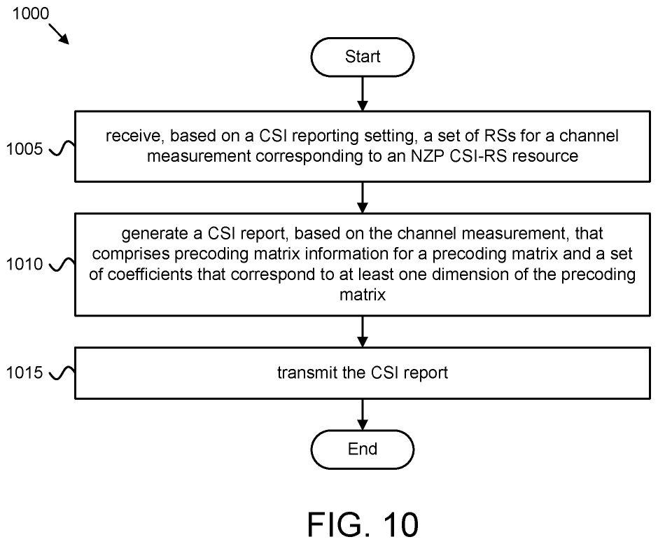

FIG. 10 illustrates a flowchart of a method 1000 that supports techniques for joint CSI training and PMI feedback for AI-enabled networks in accordance with aspects of the present disclosure. The method 1000 may be performed by a UE as described herein, for example, the remote unit 105 and/or the UE apparatus 800. In some embodiments, the method 1000 may be performed by a processor executing program code, for example, a microcontroller, a microprocessor, a CPU, a GPU, an auxiliary processing unit, a FPGA, or the like.

In one embodiment, the method 1000 begins and receives 1005, based on a CSI reporting setting, a set of RSs for channel measurement corresponding to an NZP CSI-RS resource. In one embodiment, the method 1000 generates 1010 a CSI report, based on the channel measurement, that comprises precoding matrix information for a precoding matrix and a set of coefficients that correspond to at least one dimension of the precoding matrix. In one embodiment, the method 1000 transmits 1015 the CSI report, and the method 1000 ends.

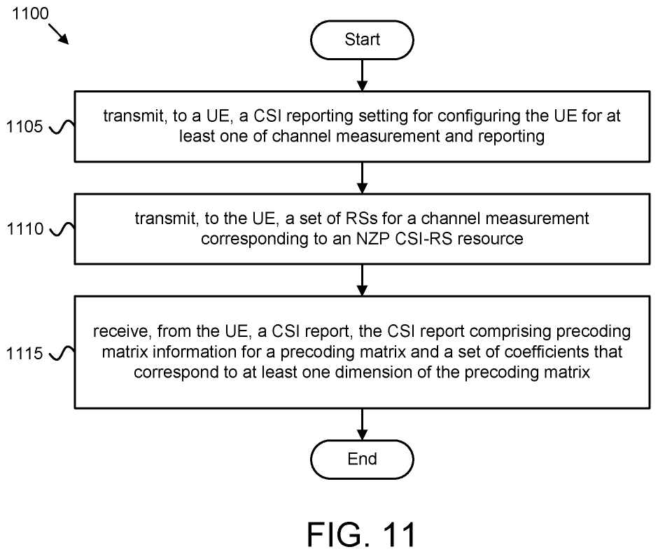

FIG. 11 illustrates a flowchart of a method 1100 that supports techniques for joint CSI training and PMI feedback for AI-enabled networks in accordance with aspects of the present disclosure. The method 1100 may be performed by a network device as described herein, for example, the base unit 121 and/or the NE apparatus 900. In some embodiments, the method 1100 may be performed by a processor executing program code, for example, a microcontroller, a microprocessor, a CPU, a GPU, an auxiliary processing unit, a FPGA, or the like.

In one embodiment, the method 1100 begins and transmits 1105, to a UE, a CSI reporting setting for configuring the UE for at least one of channel measurement and reporting. In one embodiment, the method 1100 transmits 1110, to the UE, a set of RSs for channel measurement corresponding to an NZP CSI-RS resource. In one embodiment, the method 1100 receives 1115, from the UE, a CSI report, the CSI report comprising precoding matrix information for a precoding matrix and a set of coefficients that correspond to at least one dimension of the precoding matrix, and the method 1100 ends.

Disclosed is a first apparatus for techniques for joint CSI training and PMI feedback for AI-enabled networks. The first apparatus may include a UE as described herein, for example, the remote unit 105 and/or the UE apparatus 800. In some embodiments, the first apparatus may include a processor executing program code, for example, a microcontroller, a microprocessor, a CPU, a GPU, an auxiliary processing unit, a FPGA, or the like.

In one embodiment, the first apparatus includes a processor and a memory coupled to the processor. The memory includes instructions that are executable by the processor to cause the apparatus to receive, based on a CSI reporting setting, a set of RSs for channel measurement corresponding to an NZP CSI-RS resource, generate a CSI report, based on the channel measurement, that comprises precoding matrix information for a precoding matrix and a set of coefficients that correspond to at least one dimension of the precoding matrix, and transmit the CSI report.

In one embodiment, the precoding matrix comprises a first basis transformation associated with a first dimension of the at least one dimension of the precoding matrix and the set of coefficients correspond to the precoding matrix decomposed to two subsets of coefficients corresponding to different indices of the first dimension of the precoding matrix.

In one embodiment, a first subset of the two subsets of coefficients that are associated with a second basis transformation are associated with a second dimension of the precoding matrix, and a second subset of the two subsets of coefficients that are associated with a third basis transformation are associated with the second dimension of the precoding matrix.

In one embodiment, the instructions are executable by the processor to cause the apparatus to receive, from the network, the CSI reporting setting for configuring the UE for at least one of channel measurement and reporting.

In one embodiment, the NZP CSI-RS resource comprises a plurality of CSI-RS ports.

In one embodiment, the third basis transformation transforms the second dimension of the precoding matrix from a domain comprising the plurality of CSI-RS ports to a domain comprising one or more spatial beams.

In one embodiment, the instructions are executable by the processor to cause the apparatus to transform, based on the first basis transformation, the first dimension of the precoding matrix from a domain comprising the plurality of CSI-RS ports to a domain comprising one or more spatial beams.

In one embodiment, the second basis transformation comprises at least one of an averaging over multiple indices of the second dimension into a lesser number of indices corresponding to the second dimension, a one-to-one transformation to a same number of indices corresponding to the second dimension, and a selection of a subset of indices from a set of indices corresponding to the second dimension.

In one embodiment, the second basis transformation comprises a selection of one of even-numbered indices or odd-numbered indices corresponding to the second dimension.

In one embodiment, the second basis transformation corresponds to a same type of the third basis transformation, the third basis transformation transforming the second dimension into a lesser number of indices than the second basis transformation.

In one embodiment, the third basis transformation corresponds to at least one of a transformation of the second dimension of the precoding matrix from a domain comprising a plurality of channel's frequency sub-bands to a domain comprising a transformed frequency domain basis and a transformation of the second dimension of the precoding matrix from a domain comprising a plurality of channel's time units to a domain comprising a transformed time domain basis.

In one embodiment, the first basis transformation corresponds to transforms the first dimension of the precoding matrix from at least one of a transformation of the first dimension of the precoding matrix from a domain comprising a plurality of channel's frequency sub-bands to a domain comprising a transformed frequency domain basis and a transformation of the first dimension of the precoding matrix from a domain comprising a plurality of channel's time units to a domain comprising a transformed time domain basis.

In one embodiment, the instructions are executable by the processor to cause the apparatus to represent the coefficients associated with the first subset of coefficients with a distinct codebook of quantized values as compared with coefficients associated with the second subset of coefficients.

In one embodiment, the instructions are executable by the processor to cause the apparatus to separately quantize a coefficient associated with the first subset of coefficients for each of an amplitude component and a phase component of the coefficient.

In one embodiment, the instructions are executable by the processor to cause the apparatus to jointly quantize a coefficient associated with the second subset of coefficients for both of an amplitude component and a phase component of the coefficient.

In one embodiment, the instructions are executable by the processor to cause the apparatus to jointly quantize a plurality of coefficients associated with the second subset of coefficients for at least one of amplitude components and phase components.

In one embodiment, a number of bits associated with quantizing a coefficient associated with the first subset of coefficients is larger than a number of bits associated with quantizing a coefficient associated with the second subset of coefficients.

In one embodiment, the instructions are executable by the processor to cause the apparatus to represent coefficients associated with the second subset of coefficients with a codebook from a set of pre-configured codebooks.

In one embodiment, the set of pre-configured codebooks comprises at least one of a codebook with amplitude values distributed uniformly in a linear domain and a codebook with amplitude values distributed uniformly in a logarithmic domain.

In one embodiment, the instructions are executable by the processor to cause the apparatus to configure the third basis transformation associated with the second subset of coefficients from a set of pre-configured transformation methods.

In one embodiment, the set of pre-configured transformation methods comprises at least one of a discrete Fourier transformation, a discrete cosine transformation, a discrete sine transformation, a discrete wavelet transformation, and a Haar transformation.

In one embodiment, the instructions are executable by the processor to cause the apparatus to feed back indices corresponding to vectors of a transformation matrix corresponding to the third transformation in the CSI report.

In one embodiment, indices corresponding to vectors of a transformation matrix corresponding to the third transformation are configured by the network via a higher-layer configuration.

In one embodiment, the instructions are executable by the processor to cause the apparatus to configure the UE with reporting a report quantity corresponding to a training indicator.

In one embodiment, the CSI report comprises location information corresponding to a location of the UE.

In one embodiment, the CSI report comprises a bitmap indicating indices of non-zero coefficients, and wherein coefficients corresponding to the first subset of channel coefficients are excluded from the bitmap.

In one embodiment, coefficients corresponding to the first subset of the two subsets of channel coefficients are always reported in the CSI report.

In one embodiment, the instructions are executable by the processor to cause the apparatus to configure the UE with a higher-layer parameter within the CSI reporting setting that enables or disables reporting the first subset of the two subsets of coefficients.

Disclosed is a first method for techniques for joint CSI training and PMI feedback for AI-enabled networks. The first method may by performed by a UE as described herein, for example, the remote unit 105 and/or the UE apparatus 800. In some embodiments, the first method may be performed by a processor executing program code, for example, a microcontroller, a microprocessor, a CPU, a GPU, an auxiliary processing unit, a FPGA, or the like.

In one embodiment, the first method receives, based on a CSI reporting setting, a set of RSs for channel measurement corresponding to an NZP CSI-RS resource and generates a CSI report, based on the channel measurement, that comprises precoding matrix information for a precoding matrix and a set of coefficients that correspond to at least one dimension of the precoding matrix. In one embodiment, the first method transmits the CSI report.

In one embodiment, the precoding matrix comprises a first basis transformation associated with a first dimension of the at least one dimension of the precoding matrix and the set of coefficients correspond to the precoding matrix decomposed to two subsets of coefficients corresponding to different indices of the first dimension of the precoding matrix.

In one embodiment, a first subset of the two subsets of coefficients that are associated with a second basis transformation are associated with a second dimension of the precoding matrix, and a second subset of the two subsets of coefficients that are associated with a third basis transformation are associated with the second dimension of the precoding matrix.

In one embodiment, the first method receives, from the network, the CSI reporting setting for configuring the UE for at least one of channel measurement and reporting.

In one embodiment, the NZP CSI-RS resource comprises a plurality of CSI-RS ports.

In one embodiment, the third basis transformation transforms the second dimension of the precoding matrix from a domain comprising the plurality of CSI-RS ports to a domain comprising one or more spatial beams.

In one embodiment, the first method transforms, based on the first basis transformation, the first dimension of the precoding matrix from a domain comprising the plurality of CSI-RS ports to a domain comprising one or more spatial beams.

In one embodiment, the second basis transformation comprises at least one of an averaging over multiple indices of the second dimension into a lesser number of indices corresponding to the second dimension, a one-to-one transformation to a same number of indices corresponding to the second dimension, and a selection of a subset of indices from a set of indices corresponding to the second dimension.

In one embodiment, the second basis transformation comprises a selection of one of even-numbered indices or odd-numbered indices corresponding to the second dimension.

In one embodiment, the second basis transformation corresponds to a same type of the third basis transformation, the third basis transformation transforming the second dimension into a lesser number of indices than the second basis transformation.

In one embodiment, the third basis transformation corresponds to at least one of a transformation of the second dimension of the precoding matrix from a domain comprising a plurality of channel's frequency sub-bands to a domain comprising a transformed frequency domain basis and a transformation of the second dimension of the precoding matrix from a domain comprising a plurality of channel's time units to a domain comprising a transformed time domain basis.

In one embodiment, the first basis transformation corresponds to transforms the first dimension of the precoding matrix from at least one of a transformation of the first dimension of the precoding matrix from a domain comprising a plurality of channel's frequency sub-bands to a domain comprising a transformed frequency domain basis and a transformation of the first dimension of the precoding matrix from a domain comprising a plurality of channel's time units to a domain comprising a transformed time domain basis.

In one embodiment, the first method represents the coefficients associated with the first subset of coefficients with a distinct codebook of quantized values as compared with coefficients associated with the second subset of coefficients.

In one embodiment, the first method separately quantizes a coefficient associated with the first subset of coefficients for each of an amplitude component and a phase component of the coefficient.

In one embodiment, the first method jointly quantizes a coefficient associated with the second subset of coefficients for both of an amplitude component and a phase component of the coefficient.

In one embodiment, the first method jointly quantizes a plurality of coefficients associated with the second subset of coefficients for at least one of amplitude components and phase components.

In one embodiment, a number of bits associated with quantizing a coefficient associated with the first subset of coefficients is larger than a number of bits associated with quantizing a coefficient associated with the second subset of coefficients.

In one embodiment, the first method represents coefficients associated with the second subset of coefficients with a codebook from a set of pre-configured codebooks.

In one embodiment, the set of pre-configured codebooks comprises at least one of a codebook with amplitude values distributed uniformly in a linear domain and a codebook with amplitude values distributed uniformly in a logarithmic domain.

In one embodiment, the first method configures the third basis transformation associated with the second subset of coefficients from a set of pre-configured transformation methods.

In one embodiment, the set of pre-configured transformation methods comprises at least one of a discrete Fourier transformation, a discrete cosine transformation, a discrete sine transformation, a discrete wavelet transformation, and a Haar transformation.

In one embodiment, the first method feeds back indices corresponding to vectors of a transformation matrix corresponding to the third transformation in the CSI report.

In one embodiment, indices corresponding to vectors of a transformation matrix corresponding to the third transformation are configured by the network via a higher-layer configuration.

In one embodiment, the first method configures the UE with reporting a report quantity corresponding to a training indicator.

In one embodiment, the CSI report comprises location information corresponding to a location of the UE.

In one embodiment, the CSI report comprises a bitmap indicating indices of non-zero coefficients, and wherein coefficients corresponding to the first subset of channel coefficients are excluded from the bitmap.

In one embodiment, coefficients corresponding to the first subset of the two subsets of channel coefficients are always reported in the CSI report.

In one embodiment, the first method configures the UE with a higher-layer parameter within the CSI reporting setting that enables or disables reporting the first subset of the two subsets of coefficients.

Disclosed is a second apparatus for techniques for joint CSI training and PMI feedback for AI-enabled networks. The second apparatus may include a network device as described herein, for example, the base unit 121 and/or the NE apparatus 900. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor and a memory coupled to the processor. The memory includes instructions that are executable by the processor to cause the apparatus to transmit, to a UE, a CSI reporting setting for configuring the UE for at least one of channel measurement and reporting, transmit, to the UE, a set of RSs for channel measurement corresponding to an NZP CSI-RS resource, and receive, from the UE, a CSI report. In one embodiment, the CSI report includes precoding matrix information for a precoding matrix and a set of coefficients that correspond to at least one dimension of the precoding matrix, the precoding matrix comprising a first basis transformation associated with a first dimension of the at least one dimension of the precoding matrix, the set of coefficients corresponding to the precoding matrix decomposed to two subsets of coefficients corresponding to different indices of the first dimension of the precoding matrix, a first subset of the two subsets of coefficients associated with a second basis transformation associated with a second dimension of the precoding matrix, and a second subset of the two subsets of coefficients associated with a third basis transformation associated with the second dimension of the precoding matrix.

Disclosed is a second method for techniques for joint CSI training and PMI feedback for AI-enabled networks. The second method may be performed by a network device as described herein, for example, the base unit 121 and/or the NE apparatus 900. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, a CSI reporting setting for configuring the UE for at least one of channel measurement and reporting. In one embodiment, the second method transmits, to the UE, a set of RSs for channel measurement corresponding to an NZP CSI-RS resource. In one embodiment, the second method receives, from the UE, a CSI report, the CSI report comprising precoding matrix information for a precoding matrix and a set of coefficients that correspond to at least one dimension of the precoding matrix, the precoding matrix comprising a first basis transformation associated with a first dimension of the at least one dimension of the precoding matrix, the set of coefficients corresponding to the precoding matrix decomposed to two subsets of coefficients corresponding to different indices of the first dimension of the precoding matrix, a first subset of the two subsets of coefficients associated with a second basis transformation associated with a second dimension of the precoding matrix, and a second subset of the two subsets of coefficients associated with a third basis transformation associated with the second dimension of the precoding matrix.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments oflike elements.

1. A user equipment (UE) for wireless communication, comprising:
a processor; and
a memory coupled to the processor, the memory comprising instructions executable by the processor to cause the UE to:
receive, based on a channel state information (“CSI”) reporting setting, a set of reference signals (“RSs”) for a channel measurement corresponding to a non-zero power (“NZP”) CSI-RS resource;
generate a CSI report based on the channel measurement, the CSI report comprising precoding matrix information for a precoding matrix and a set of coefficients that correspond to at least one dimension of the precoding matrix; and
transmit the CSI report.

2. The UE of claim 1, wherein the precoding matrix comprises a first basis transformation associated with a first dimension of the at least one dimension of the precoding matrix and the set of coefficients correspond to the precoding matrix decomposed to two subsets of coefficients corresponding to different indices of the first dimension of the precoding matrix.

3. The UE of claim 2, wherein a first subset of the two subsets of coefficients that are associated with a second basis transformation are associated with a second dimension of the precoding matrix, and a second subset of the two subsets of coefficients that are associated with a third basis transformation are associated with the second dimension of the precoding matrix.

4. The UE of claim 3, wherein the second basis transformation comprises at least one of:
an average over multiple indices of the second dimension into a lesser number of indices corresponding to the second dimension;
a one-to-one transformation to a same number of indices corresponding to the second dimension;
a selection of a subset of indices from a set of indices corresponding to the second dimension; or
a selection of even-numbered indices or odd-numbered indices corresponding to the second dimension.

5. The UE of claim 3, wherein the third basis transformation transforms the second dimension of the precoding matrix from a domain comprising a plurality of CSI-RS ports to a domain comprising one or more spatial beams.

6. The UE of claim 3, wherein the second basis transformation corresponds to a same type of the third basis transformation, the third basis transformation transforming the second dimension into a lesser number of indices than the second basis transformation.

7. The UE of claim 3, wherein the third basis transformation corresponds to at least one of:
a transformation of the second dimension of the precoding matrix from a domain comprising a plurality of channel frequency sub-bands to a domain comprising a transformed frequency domain basis; or
a transformation of the second dimension of the precoding matrix from a domain comprising a plurality of channel time units to a domain comprising a transformed time domain basis.

8. The UE of claim 3, wherein the instructions are executable by the processor to cause the UE to configure the third basis transformation associated with the second subset of the two subsets of coefficients from a set of pre-configured transformations, wherein the set of pre-configured transformations comprises at least one of a discrete Fourier transformation, a discrete cosine transformation, a discrete sine transformation, a discrete wavelet transformation, or a Haar transformation.

9. The UE of claim 2, wherein the instructions are executable by the processor to cause the UE to transform, based on the first basis transformation, the first dimension of the precoding matrix from a domain comprising a plurality of CSI-RS ports to a domain comprising one or more spatial beams.

10. The UE of claim 2, wherein the instructions are executable by the processor to cause the UE to represent coefficients associated with a first subset of the two subsets of coefficients with a distinct codebook of quantized values, and wherein a number of bits associated with quantizing a coefficient associated with the first subset of the two subsets of coefficients is larger than a number of bits associated with quantizing a coefficient associated with a second subset of the two subsets of coefficients.

11. The UE of claim 2, wherein the instructions are executable by the processor to cause the UE to configure the UE with a higher-layer parameter within the CSI reporting setting that enables or disables reporting of a first subset of the two subsets of coefficients.

12. The UE of claim 1, wherein the instructions are executable by the processor to cause the UE to report a report quantity corresponding to a training indicator.

13. The UE of claim 1, wherein the NZP CSI-RS resource comprises a plurality of CSI-RS ports.

14. A method of a user equipment (UE), comprising:
receiving, based on a channel state information (“CSI”) reporting setting, a set of reference signals (“RSs”) for a channel measurement corresponding to a non-zero power (“NZP”) CSI-RS resource;
generating a CSI report based on the channel measurement, the CSI report comprising precoding matrix information for a precoding matrix and a set of coefficients that correspond to at least one dimension of the precoding matrix; and
transmitting the CSI report.

15. A network entity for wireless communication, comprising:
a processor; and
a memory coupled to the processor, the memory comprising instructions executable by the processor to cause the network entity to:
transmit, to a user equipment (“UE”), a channel state information (“CSI”) reporting setting for configuring the UE for at least one of channel measurement and reporting;
transmit, to the UE, a set of reference signals (“RSs”) for a channel measurement corresponding to a non-zero power (“NZP”) CSI-RS resource; and
receive, from the UE, a CSI report, the CSI report comprising precoding matrix information for a precoding matrix and a set of coefficients that correspond to at least one dimension of the precoding matrix.

16. A processor for wireless communication, comprising:
at least one controller coupled with at least one memory and configured to cause the processor to:
receive, based on a channel state information (“CSI”) reporting setting, a set of reference signals (“RSs”) for a channel measurement corresponding to a non-zero power (“NZP”) CSI-RS resource;
generate a CSI report based on the channel measurement, the CSI report comprising precoding matrix information for a precoding matrix and a set of coefficients that correspond to at least one dimension of the precoding matrix; and
transmit the CSI report.

17. The processor of claim 16, wherein the precoding matrix comprises a first basis transformation associated with a first dimension of the at least one dimension of the precoding matrix and the set of coefficients correspond to the precoding matrix decomposed to two subsets of coefficients corresponding to different indices of the first dimension of the precoding matrix.

18. The processor of claim 17, wherein a first subset of the two subsets of coefficients that are associated with a second basis transformation are associated with a second dimension of the precoding matrix, and a second subset of the two subsets of coefficients that are associated with a third basis transformation are associated with the second dimension of the precoding matrix.

19. The processor of claim 18, wherein the second basis transformation comprises at least one of:
an average over multiple indices of the second dimension into a lesser number of indices corresponding to the second dimension;
a one-to-one transformation to a same number of indices corresponding to the second dimension;
a selection of a subset of indices from a set of indices corresponding to the second dimension; or
a selection of even-numbered indices or odd-numbered indices corresponding to the second dimension.

20. The processor of claim 18, wherein the third basis transformation transforms the second dimension of the precoding matrix from a domain comprising a plurality of CSI-RS ports to a domain comprising one or more spatial beams.
